(19) United States
(12) Patent Application Publication
(10) Pub. No.: US 2013/0110789 A1
(43) Pub. Date: May 2, 2013

(54) METHOD OF, AND APPARATUS FOR, RECOVERING DATA ON A STORAGE SYSTEM

(71) Applicants: Peter BRAAM, Nederland, CO (US); Nikita Y. DANILOV, Moscow (RU)

(72) Inventors: Peter BRAAM, Nederland, CO (US); Nikita Y. DANILOV, Moscow (RU)

(73) Assignee: Xyratex Technology Limited, Havant (GB)

(21) Appl. No.: 13/283,169

(22) Filed: Oct. 27, 2011

(51) Int. Cl. G06F 7/00

(52) U.S. Cl. 707/675; 707/E17.01; 707/E17.007

(57) ABSTRACT

There is provided a method of, and apparatus for, enabling data recovery on a data storage resource. The resource includes a file system having a file system structure component for data storage management. In use, a storage request operable to modify the file system is received, processed and the file system structure component updated based on the storage request. Subsequently, a data record recording the modification by the storage request is generated and used to update an auxiliary file system structure component separate from the file system structure component. By providing such a method, a file system structure can be recreated and recovered quickly after a failure or error utilising the auxiliary file system structure component. This enables a file system to be reconstructed much faster than conventional approaches because the auxiliary file system structure has already been created.

The present invention relates to a method of, and apparatus for, recovering data on a storage system. More particularly, the present invention relates to a method of and apparatus for, recovering data on a storage system with minimal downtime subsequent to a system failure or error.

A typical storage system generally comprises a server and a plurality of hard disk drives connected together over a network to one or more servers, each of which provides a network-addressable storage resource. Alternatively, the storage system may comprise a local configuration where the storage resource is connected directly to a terminal or server or may form a local storage arrangement such as a hard disk drive in a laptop or personal computer.

Data protection and integrity is an important aspect of a storage system, and at each level of abstraction, a number of protection measures are provided to ensure data integrity. A hard disk drive is an electro-mechanical device which may be prone to errors and or damage. Therefore, commonly, hard disk drives set aside a portion of the available storage in each sector for the storage of error correcting codes (ECCs). The ECC can be used to detect corrupted or damaged data and, in many cases, such errors are recoverable through use of the ECC. However, in cases such as enterprise storage architectures, the risks of such errors occurring are still too great and need to be reduced.

An example of an approach to improve the reliability of a hard disk drive storage system is to employ redundant arrays of inexpensive disks (RAID). Indeed, RAID arrays are the primary storage architecture for large, networked computer storage systems.

There are a number of different RAID architectures Commonly-used architectures comprise RAID-1 through to RAID-6. Each architecture offers disk fault-tolerance and offers different trade-offs in terms of features and performance. A RAID network is generally controlled by one or more RAID controllers which manage the physical storage of data on the drives forming part of the RAID array. RAID controllers provide data integrity through redundant data mechanisms, high speed through streamlined algorithms, and accessibility to stored data for clients and administrators. Should one of the disks in a RAID group fail or become corrupted, the missing data (usually in the form of blocks) can be recreated from the data on the other disks.

However, whilst a RAID array has been described in embodiments as a storage architecture for use with the present invention, this need not necessarily be the case. Any suitable storage or hard disk protocol may be used with the present invention.

At a higher level of abstraction, an Operating System (OS) is run on the server. The OS comprises a file system which presents a client-addressable interface through which data can be stored, addressed and modified on a RAID array or other storage arrangement.

A file system is operable to track and manage where data is stored on the storage system and where free or available storage space exists on the storage system. Clustered file systems can store many millions of files which are often distributed across a multiplicity of storage devices, such as hard disk drives. Non-exhaustive examples of typical file systems with which the invention may be used include: NTFS, HFS, ext3 and ext4.

Certain consistency rules amongst the data structures in a file system must be obeyed in order for the file system to function correctly. However, hardware and software errors or problems can cause these rules to be violated, often resulting in a catastrophic failure of a file system. Hardware errors may occur from mechanical problems in, for example, a hard drive or drives, or data corruption due to communication errors or power failures. Software errors may, for example, originate from software bugs (in file system drivers, libraries, operating system kernels, compilers, etc.). These errors are a fundamentally unavoidable source of catastrophic failures, which grows in importance in proportion to the system complexity. With storage systems increasingly being used to provide high data volume “cloud” type services, the size of these systems increases their vulnerability to such catastrophic failures.

It is known for file systems to comprise a “replay log” which is invoked in the circumstance of, for example, unexpected loss of power or incomplete updates. However, this arrangement only retains a record of the requests received by the file system and has no facility to check for and/or correct errors. The present invention is not concerned with such “replay logs”.

File system checkers and scavengers are known. These system components enable checking of a file system and recovery of a storage system after a catastrophic failure due to hardware and software faults.

File system checkers check the file system data structures for consistency and, if necessary, make changes to bring them into a consistent state. Should a restore be necessary, a file system checker scans the major data structures of the file system and building a collection of temporary indices. The temporary indices are then used to find valid fragments of the file system state and to resolve conflicts between the corrupted fragments.

However, traditional file system checker solutions recover a file system in a time proportional to the size of the file system. Current storage systems often comprise many Terabytes or even Petabytes of storage capacity. Therefore, the time required to recover a storage system is considerable and may, in some cases, be up to a week. This results in an unacceptably long period in which the storage system is unavailable for access whilst the storage system is checked, repaired or recovered.

Therefore, known storage systems suffer from a technical problem that conventional approaches to system recovery after a catastrophic failure are unsuitable for high-demand, high-capacity systems due to the excessive downtime required to rebuild or repair a large storage system after the failure has occurred. Therefore, there exists a need to provide a method and system which is able to recover a file system after failure in a reduced time period.

According to a first aspect of the present invention, there is provided a method of enabling data recovery on a storage system comprising at least one data storage resource, the or each data storage resource comprising a file system operable to process storage requests to said data storage resource from one or more client computers, the file system including a file system structure component for data storage management on said data storage resource, the method comprising: a) receiving, on a computer system, a storage request operable to modify the file system; b) processing, on a computer system, the storage request and updating the file system structure component based on said storage request; c) generating, on a computer system, a data record for said modification by said storage request; d) updating, on a computer system, an auxiliary file system structure component utilising said data record, the auxiliary file system structure component being separate from said file system structure component and being operable to enable recovery of said file system in the event of an error or failure occurring.

By providing such a method, a file system structure can be recreated and recovered quickly after a catastrophic failure or error by using the file system structure image. This enables a file system to be reconstructed much faster than conventional approaches because the image file system structure has already been created.

In contrast, known arrangements are required to build a set of data structure indices after a failure or error has occurred. This requires a prohibitive amount of system resource and time whilst the entire storage system is scanned to build up the required indices. In modern systems which may comprise many Terabytes or even Petabytes of storage capacity, the time required to do this is prohibitive.

In one embodiment, steps b) and c) are performed synchronously.

In one embodiment, step d) is carried out asynchronously from steps b) and c).

In one embodiment, step d) further comprises waiting for a predetermined time period prior to updating said auxiliary file system structure component.

In one embodiment, said pre-determined time period is dependent upon the load on the data storage resource.

In one embodiment, the or each data record is stored in a file operations log comprising a plurality of data records recording storage requests modifying the file system structure component.

In one embodiment, said file operations log is immutable.

In one embodiment, said file system structure component and/or said auxiliary file system structure component comprise one or more tables relating to data storage allocation on said data storage resource.

In one embodiment, said tables comprise one or more arrays relating one or more files to a specific data storage allocation area on said storage resource.

In one embodiment, said data storage allocation area comprises one or more data blocks.

In one embodiment, the method further comprises the step of: f) determining, from said updating in step d), whether errors are present in said file system structure component and, if an error is detected, correcting said error in the file system structure component.

In one embodiment, said correcting comprises rebuilding the file system structure component from the auxiliary file system structure component.

In one embodiment, the method further comprises the step of: g) rebuilding the file system structure component from the auxiliary file system structure component.

According to a second aspect of the present invention, there is provided a method of enabling data recovery on a storage system comprising at least one data storage resource, the or each data storage resource comprising a file system operable to process storage requests to said data storage resource from one or more client computers, the file system including a file system structure component for data storage management on said data storage resource, the method comprising: a) receiving, on a computer system, a storage request requesting a modification to the file system; b) generating, on a computer system, a data record for said modification by said storage request; c) updating, on a computer system, an auxiliary file system structure component utilising said data record, said auxiliary file system structure component being separate from said file system structure component; d) determining, from said updating in step e), whether errors are present in said file system structure component and, if an error is detected, correcting said error in the file system structure component; and f) processing, on a computer system, the storage request and updating the file system structure component based on said storage request.

In one embodiment, said correcting in step d) comprises rebuilding the file system structure component from the auxiliary file system structure component.

In one embodiment, if an error is detected such that the storage request received in step a) is allocated to an incorrect data storage allocation area, the processing in step f) comprises allocating the storage request to the correct data storage allocation area.

In one embodiment, if no error is detected, the processing in step f) comprises executing the request as received by the data storage resource.

According to a third aspect of the present invention, there is provided a controller operable to enable data recovery on a storage system comprising at least one data storage resource, the or each data storage resource comprising a file system operable to process storage requests to said data storage resource from one or more client computers, the file system including a file system structure component for data storage management on said data storage resource, the controller being operable to; receive a storage request operable to modify the file system; process the storage request and update the file system structure component based on said storage request; generate a data record for said modification by said storage request; and update an auxiliary file system structure component utilising said data record, the auxiliary file system structure component being separate from said file system structure component and being operable to enable recovery of said file system in the event of an error or failure occurring.

In one embodiment, the controller is further operable to determine, from the operation of updating the auxiliary file system structure component, whether errors are present in said file system structure component and, if an error is detected, correct said error in the file system structure component.

In one embodiment, said operation of correcting comprises rebuilding the file system structure component from the auxiliary file system structure component.

In one embodiment, the controller is further operable to rebuild the file system structure component from the auxiliary file system structure component.

In one embodiment, the controller is operable to enable data recovery on a storage system comprising a plurality of data storage resources each comprising a file system.

In one embodiment, the controller is implemented in either hardware or software.

According to a fourth aspect of the present invention, there is provided a controller operable to enable data recovery on a storage system comprising at least one data storage resource, the or each data storage resource comprising a file system operable to process storage requests to said data storage resource from one or more clients, the file system including a file system structure component for data storage management on said data storage resource, the controller being operable to: receive a storage request requesting a modification to the file system; generate a data record for said modification by said storage request; update an auxiliary file system structure component utilising said data record, said auxiliary file system structure component being separate from said file system structure component; determine, from said operation of updating, whether errors are present in said file system structure component and, if an error is detected, correct said error in the file system structure component; and process the storage request and update the file system structure component based on said storage request.

According to a fifth aspect of the invention, there is storage system comprising at least one data storage resource and the controller of the third or fourth aspects.

According to a sixth aspect of the present invention, there is provided a computer program product executable by a programmable processing apparatus, comprising one or more software portions for performing the steps of the first and/or second aspects.

According to a seventh aspect of the present invention, there is provided a computer usable storage medium having a computer program product according to the sixth aspect stored thereon.

Embodiments of the present invention will now be described in detail with reference to the accompanying drawings, in which:

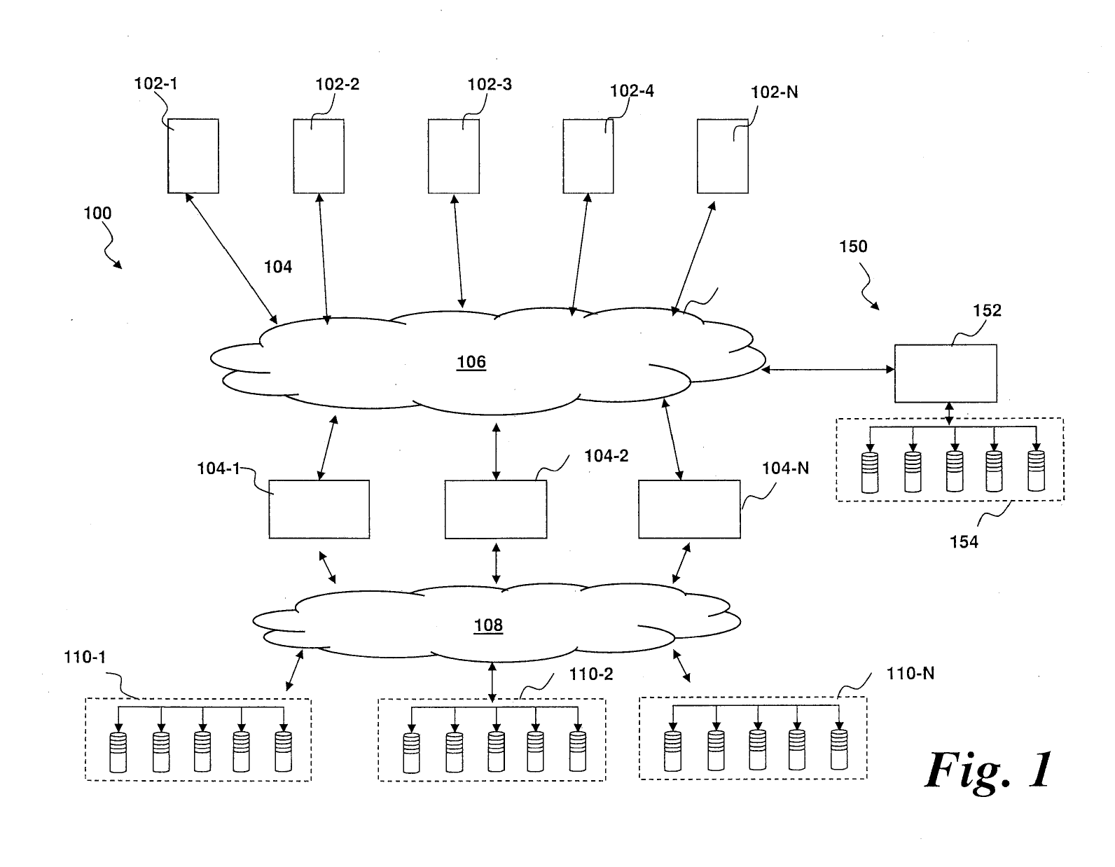

FIG. 1 is a schematic diagram of a networked storage system according to an embodiment of the present invention;

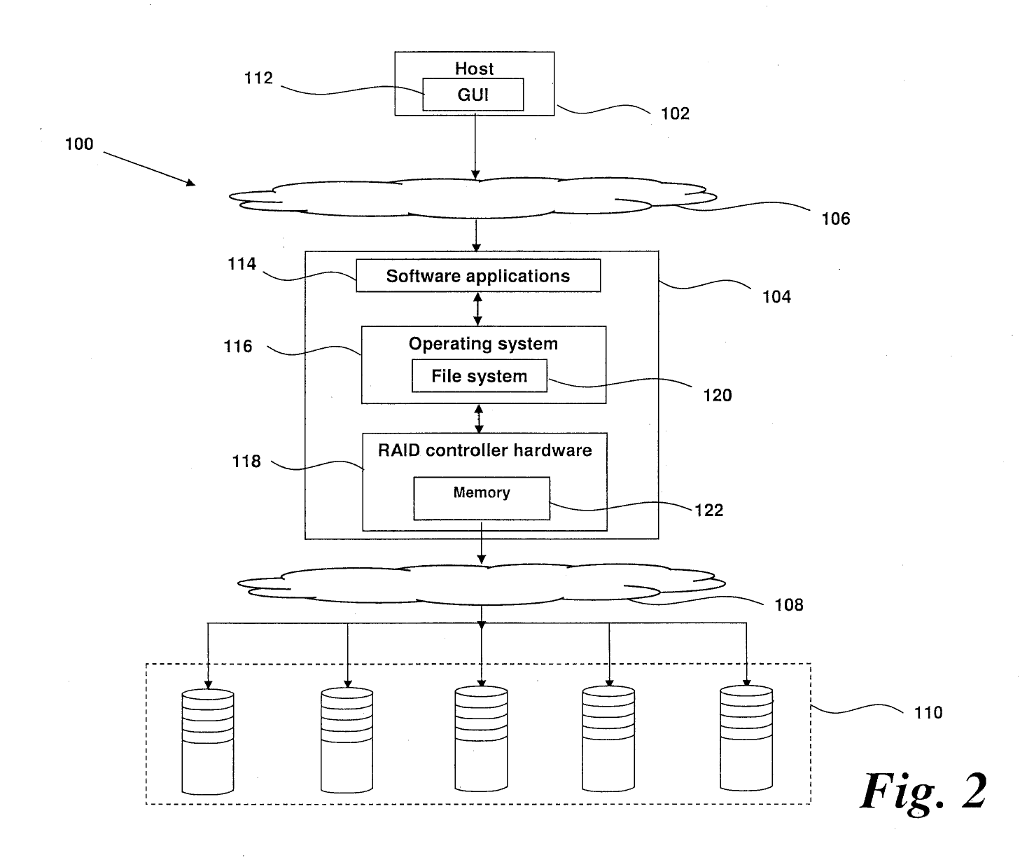

FIG. 2 is a more detailed schematic diagram showing a single server and storage device of an embodiment;

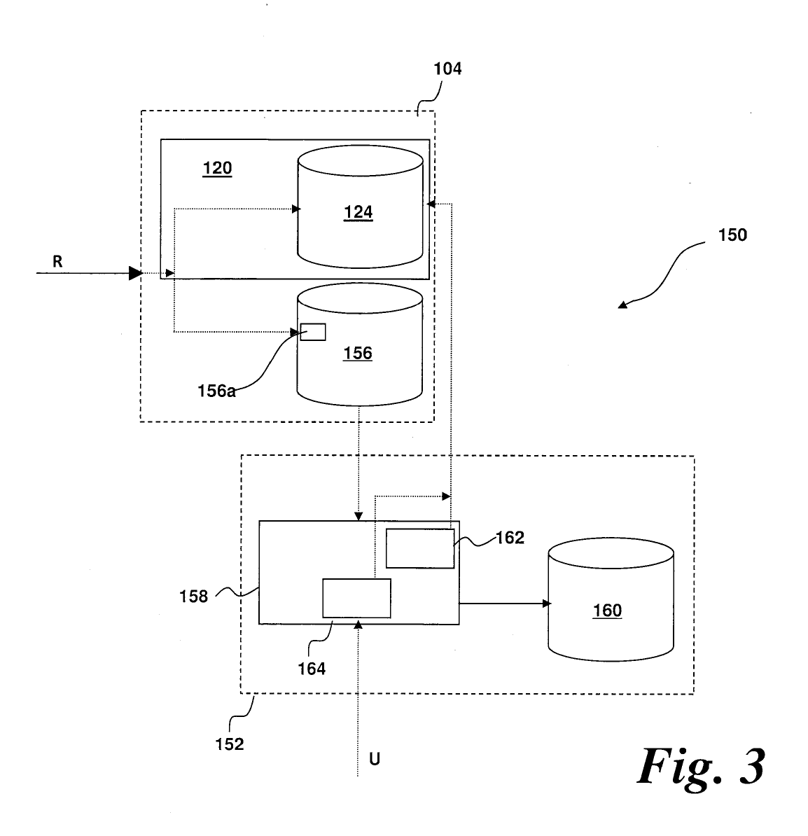

FIG. 3 is a schematic diagram showing the components of the data recovery system of an embodiment;

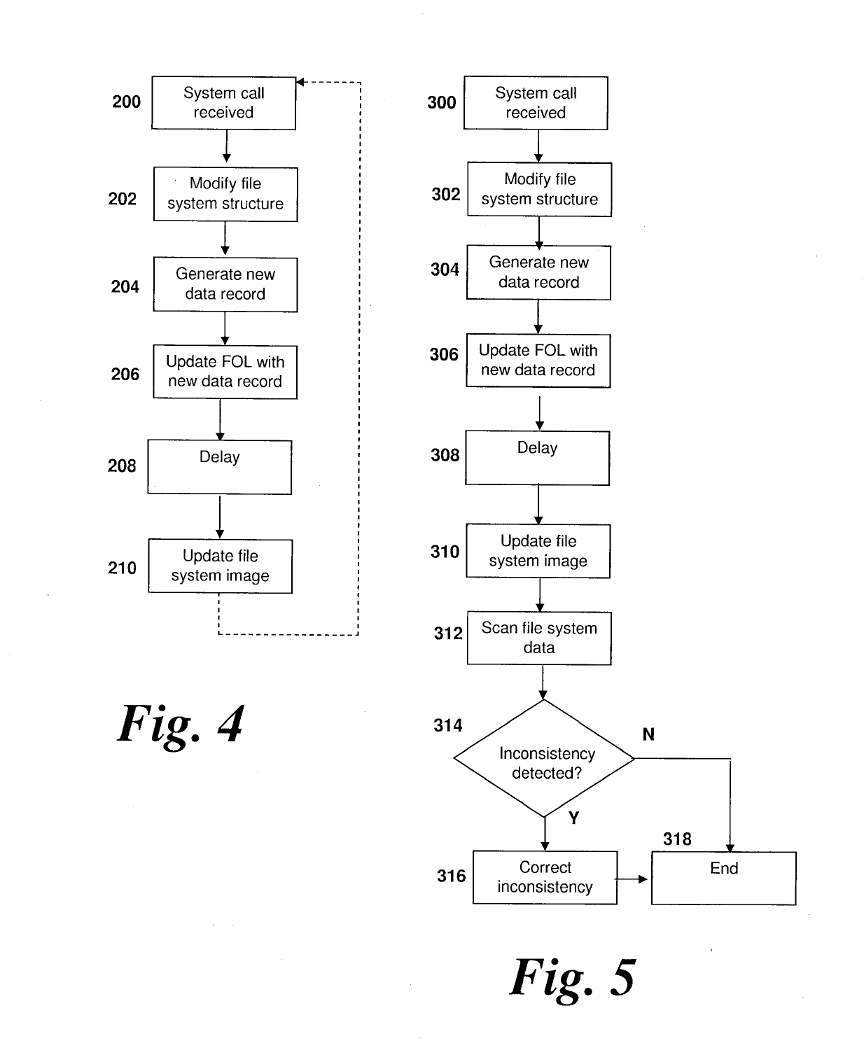

FIG. 4 is a flowchart showing one embodiment of a method of operation of the present invention;

FIG. 5 is a flowchart showing an alternative embodiment of a method of operation of the present invention;

FIG. 6 is a flowchart showing a further alternative embodiment of a method of operation of the present invention; and

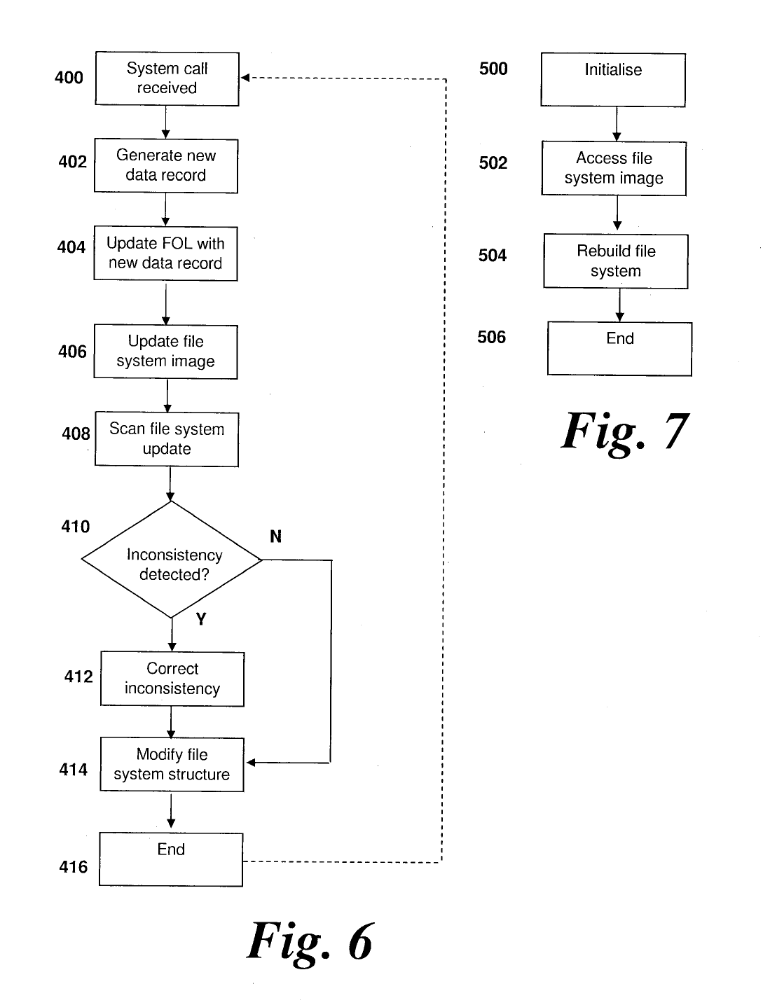

FIG. 7 is a flowchart showing a recovery method of the present invention.

Embodiments of the present invention provide a method of preventing failure of a cluster file system or, in the event of a catastrophic failure, reducing the time required to recover a cluster file system.

FIG. 1 shows a schematic illustration of a networked storage resource 100 in which the present invention may be used. However, it is to be appreciated that a networked storage resource is only one possible implementation of a storage resource which may be used with the present invention. Indeed, the storage resource need not necessarily be networked and may comprise, for example, systems with local or integrated storage resources such as a personal computer, laptop, so-called “smartphone” or personal data assistant (PDA).

The networked storage resource 100 comprises a cluster file system. A cluster file system consists of client 102-1 to 102-N and server 104-1 to 104-N nodes, connected by a network 106. Client applications, running on client nodes, make storage requests (which may comprise file storage requests) against the cluster file system. Some of these calls result in updates to the file system state, recorded in volatile and persistent stores of node.

The networked storage resource comprises a plurality of hosts 102. The hosts 102 are representative of any computer systems or terminals that are operable to communicate over a network. Any number of hosts 102 or servers 104 may be provided; N hosts 102 and N servers 104 are shown in FIG. 1, where N is an integer value.

The hosts 102 are connected to a first communication network 106 which couples the hosts 102 to a plurality of servers 104. The communication network 106 may take any suitable form, and may comprise any form of electronic network that uses a communication protocol; for example, a local network such as a LAN or Ethernet, or any other suitable network such as a mobile network or the interne.

The servers 104 are connected through device ports (not shown) to a second communication network 108, which is also connected to a plurality of storage devices 110-1 to 110-N. The second communication network 108 may comprise any suitable type of storage controller network which is able to connect the servers 104 to the storage devices 20. The second communication network 108 may take the form of, for example, a SCSI network, an iSCSI network or fibre channel.

The servers 104 may comprise any storage controller devices that process commands from the hosts 102 and, based on those commands, control the storage devices 110. The storage devices 110 may take any suitable form; for example, tape drives, disk drives, non-volatile memory, or solid state devices.

Although most RAID architectures use hard disk drives as the main storage devices, it will be clear to the person skilled in the art that the embodiments described herein apply to any type of suitable storage device. More than one drive may form a storage device 110; for example, a RAID array of drives may form a single storage device 110. The skilled person will be readily aware that the above features of the present embodiment could be implemented in a variety of suitable configurations and arrangements. Additionally, each storage device 110 comprising a RAID array of devices appears to the hosts 102 as a single logical storage unit (LSU) or drive. Any number of storage devices 110 may be provided; in FIG. 1, N storage devices 110 are shown, where N is any integer value.

The operation of the servers 104 may be set at the Application Programming Interface (API) level. Typically, Original Equipment Manufactures (OEMs) provide RAID networks to end clients for network storage. OEMs generally customise a RAID network and tune the network performance through an API.

The servers 104 and storage devices 110 also provide data redundancy. The storage devices 110 comprise RAID controllers which provide data integrity through a built-in redundancy which includes data mirroring. The storage devices 110 are arranged such that, should one of the drives in a group forming a RAID array fail or become corrupted, the missing data can be recreated from the data on the other drives.

FIG. 2 shows a more detailed schematic diagram of a single host 102 and single server 104 which may form the whole or part of the storage resource 100.

The host 102 comprises a general purpose computer (PC) which is operated by a client and which has access to the storage resource 100. A graphical user interface (GUI) 112 is run on the host 102. The GUI 112 is a software application which acts as a user interface for a client of the host 102.

The server 104 comprises a software application layer 114, an operating system 116 and RAID controller hardware 118. The software application layer 114 comprises software applications including the algorithms and logic necessary for the initialisation and run-time operation of the server 104. The software application layer 114 includes software functional blocks such as a system manager for fault management, task scheduling and power management. The software application layer 114 also receives commands from the host 102 (e.g., assigning new volumes, read/write commands) and executes those commands. Commands that cannot be processed (because of lack of space available, for example) are returned as error messages to the client of the host 102.

The operating system 116 utilises an industry-standard software platform such as, for example, Linux, upon which the software applications forming part of the software application layer 114 can run. The operating system 116 comprises a file system 120 which enables the RAID controller 104 to store and transfer files and interprets the data stored on the primary and secondary drives into, for example, files and directories for use by the operating system 120.

The RAID controller hardware 118 is the physical processor platform of the RAID controller 104 that executes the software applications in the software application layer 116. The RAID controller hardware 118 comprises a microprocessor, memory 122, and all other electronic devices necessary for RAID control of the storage devices 110. However, the controller hardware need not be in the form of RAID hardware and other storage architectures may be utilised and controlled by the controller and fall within the scope of the present invention.

Whilst, in FIG. 2, the RAID controller hardware 118 is shown as part of the server 104, this need not be so. The skilled person would be readily aware of alternatives which fall within the scope of the present invention; for example, the RAID controller hardware 118 may be remote from the server 104. In addition, the RAID controller hardware 118 may be located together with the storage devices 110 or remotely therefrom.

Referring back to FIG. 1, an auxiliary data recovery system 150 is also provided. The auxiliary data recovery system 150 comprises an auxiliary server 152 and associated storage device 154 operable to implement an auxiliary file system monitor according to an embodiment.

In this embodiment, the auxiliary file system monitor is located on the auxiliary server 152 which is separate from the server 104 or servers 104-i on which the file system 120 operates. This is so that the auxiliary data structures (which will be discussed later) can be stored on the separate storage device 154 from the storage devices 110 of the storage resource 100 and are, as a result, protected from failure therewith.

However, this need not be the case. The auxiliary file system monitor may, alternatively, comprise a software application or run-time component of the OS 116 or file system 120 of the storage resource 100. The skilled person would readily be aware of alternatives or variations which fall within the scope of the present invention.

FIG. 3 shows a schematic diagram of the components of an embodiment of the present invention. An auxiliary data recovery system 150 is provided. The auxiliary data recovery system 150 is associated with one or more servers 104. The servers 104, as described above, are specified as general components of a networked storage resource 100 and may comprise any suitable networked computer system capable of receiving and issuing storage requests (such as I/O requests) and data transfers. However, the auxiliary data recovery system 150 may also be utilised with a computing device having local storage, such as a personal computer or laptop with an internal hard drive or flash memory.

The server 104 is operable to receive storage requests R (which may comprise I/O requests) to a file system 120 from hosts or clients 102 and process said storage requests to the file system 120. The file system 120 may comprise any suitable system and may be run on the server 104 to provide access to the storage devices 110. Non-exhaustive examples of suitable file systems may be: NTFS, HFS, ext3 or ext4. The file system 120 comprises a set of file system persistent structures 124. The file system persistent structures 124 comprise a set of file system tables which relate to storage device space management; an example of file system tables may be free space tables.

The file system 120 enables the storage on the storage device 110 to be externally visible as a set of numbered blocks of fixed size to the clients 102. In order to do so, the file system persistent structures 124 on the server 104 comprise tables related to device space management. Such table information includes, for each file on the storage resource 100, a set of device block numbers identifying blocks where file data is stored and a list of a set of free blocks which do not hold file data. The free blocks may be used to extend files.

A file operations log (FOL) 156 is provided on the server 104. The FOL 156 comprises a record of updates to the file system state. The file system 120 is updated whenever a particular storage request R (e.g. a write request) makes a modification to the state of the file system 120; for example, when new data is written to a storage resource. Whenever such a request R is received, the FOL 156 is updated to include information relating to the update.

In this embodiment, the FOL 156 is located on the server 104. However, this need not be so and the FOL 156 may be located on the auxiliary server 152 or elsewhere.

The information relating to the update may comprise any suitable form of data or metadata representative of the change to the file state. The FOL 156 takes the form of an ordered stream of data listing the updates to the file system 120. The FOL 156 is immutable, i.e. the FOL 156 cannot be modified once it has been created. The FOL 156 may comprise a look up table (LUT) in which the metadata records of the updates is stored. The auxiliary file system monitor 158 produces FOL 156 records as a by-product of processing client application storage requests R.

When a client application running on a client 102 makes a call or storage request R to the file system 120 (e.g., the creation of a new directory or a write to a file) that updates the file system state, one or more records 156a are added to the FOL 156. For example, a command R to write to data to a file F may be expressed as a WRITE(F, data) operation issued by a client 102. This would create a FOL record 156a describing the operation. The record 156a describes updates to the system tables incurred by the operation. Specifically, if the operation required allocation of new data blocks to the file F, the record would list the block numbers of the new data blocks. The record 156a is stored persistently on the server 104 as part of the same transaction in which the operation is executed.

In other words, each record 156a describe the operation itself (e.g. write or modification to a file or directory) together with the details of its execution (e.g. the identifier of a newly created directory, or the physical addresses of blocks modified by the write or file creation). In other words, the FOL 156 comprises a record 156a or entry for each modification of the file system state performed directly or indirectly as a result of file system client requests.

The FOL 156 is continuously updated when the file system 120 is in use. Therefore, the FOL 156 maintains a current record of the updates occurring on the file system 120 whilst the file system 120 is in operation. Collectively, the FOL 156 records the full history of the file system 120.

The FOL 156 is utilised by an auxiliary file system monitor 158. The auxiliary file system monitor 158 is operable to utilise the records stored in the FOL 156 and periodically build or add to a auxiliary file system structure 160. The auxiliary file system structure 160 comprises a set of data structures which can be utilised to rebuild the file system 120 should a catastrophic error occur. The auxiliary file system structure 160 may be stored on the storage device 154 (as is the case in this embodiment) or within the memory or other storage application of the server 152 or server 104.

It is useful, but not essential, for the auxiliary file system structure 160 to be different in format or configuration from the file system structure 124. This reduces the likelihood of an error in the file system structure 124 being repeated in the auxiliary file system structure 160.

Therefore, the FOL 156 records are processed by the auxiliary file system monitor 158 to build additional data-structures (the auxiliary file system structure 160) that are not necessary for a normal operation of a file system, but useful for its recovery. Non-exhaustive examples of such data-structures may include: a table mapping each storage device block to a file which this block is allocated to; or a table assigning to each directory its depth in a name-space hierarchy.

By way of example, the auxiliary file system structure 160 may comprise a set of auxiliary tables comparable (but not necessarily identical at any point in time) to the file system persistent structures 124. The auxiliary tables are updated as the auxiliary file system monitor 158 processes the records 156a-i on an individual basis.

An example of a suitable table is an array which records, for each device block number allocated to each file, if any. To process the record 156a, the auxiliary file system monitor 158 extracts a list of block numbers allocated to the file F to which the record 156a relates, and updates the array forming part of the auxiliary file system structure 160 correspondingly.

The FOL 156 is continuously updated every time a relevant change or update is made to the file system 120. The auxiliary file system structure 160 may also be updated at this time and used as a verification process (described later) to ensure that the most recent update has not generated a corruption or error.

Alternatively, the auxiliary file system structure 160 is, in one embodiment, updated asynchronously and periodically using the records stored in the FOL 156. When the FOL 156 is updated, the updated records are, at a later time period (for example, when the system resources are less utilised) sent to the auxiliary file system monitor 158 to update the auxiliary file system structure 160. This delay is in order to reduce the system overheads associated with the building of the updated auxiliary file system structure 160 whilst a client is accessing the file system 120.

In other words, the asynchronous processing of FOL 156 records by the auxiliary file system monitor 158 removes the delay of index maintenance from the client-visible file system latency during system access.

However, even though the FOL records 156a are processed asynchronously by the auxiliary file system monitor 158, the records are processed in transaction order and updated regularly by the auxiliary file system monitor 158 to ensure that the auxiliary file system structure 160 is representative of the current state of the file system 120.

The updating may occur in a form which is substantially simultaneous, depending upon demand on the system resources. For example, if the server 104 is lightly utilised and has sufficient capacity, the auxiliary file system structure 160 may be updated almost synchronously with the addition of a record 156a to the FOL 156. In the alternative, if the server 104 is experiencing high traffic volumes, the update may be scheduled to wait until spare capacity becomes available.

In other words, the transactional nature of the FOL 156 records processing guarantees that the pre-emptive file system checked state (e.g. the state of the auxiliary file system structure 160) is consistent with the rest of file system state should node and/or network failures occur whilst not placing excess demand on system resources and increasing the file system latency for clients accessing the file system 120.

An alternative example is the use of a metadata server which handles directory structures of a file system. The metadata server maintains a table, recording identifies and names of files in directories. The auxiliary file system monitor 158 maintains an array in the checker persistent structures 160, recording for each file the name and parent directory of the file.

By way of example, if due to a bug, a directory table becomes corrupted and its name is lost/ Then, when a second storage request attempts to create a directory table having the same name, thehe auxiliary file system monitor 158 would detect this and would invoke an asynchronous mode as described below.

A synchronous (or on-demand) corruption detection only happens when an inconsistent part of file system is actually accessed. Alternatively, an asynchronous mode (or preventative) may be used, where a server scans its tables in the background and sends them to the auxiliary file system monitor 158 for verification. The synchronous and asynchronous modes are described in detail in the method steps outlined below.

The auxiliary file system monitor 158 further comprises recovery elements 162, 164. The recovery elements 112, 114 comprise a pre-emptive file recovery component 162 and an on-demand file recovery component 164.

The pre-emptive file system recovery component 162 is operable to initiate actions to repair the file system 120 when inconsistencies are found in the scanned and processed data, without the file system 120 notifying the processing system of errors or corruption. In other words, the pre-emptive file system recovery component 162 monitors the auxiliary file system structure 160 and, if an inconsistency is identified, corrects the inconsistency in the file system structure 120 itself.

This is possible by means of a continuous maintenance of the FOL 156 as the file system 120 is accessed in use, and the timely, but asynchronous, updating of the checker file system image 110 by the auxiliary file system monitor 158 during operation of the file system 120. Therefore, errors in the file system structure not identified by the file system 120 itself (or associated error checking means) can be monitored and identified by the pre-emptive file system recovery component 162 to in order to take preventative action, eliminating the need for later on-demand action to be taken.

As an example of this, suppose that due to a software bug in the server code or some media failure, a table storing the set of free blocks becomes corrupted. The corruption may be such that some block already allocated to a file F now appears to be free. When this block gets allocated to another file, as part of a WRITE operation, the record 156a-i, of this operation will be sent to the auxiliary file system monitor 158 to update the auxiliary file system structure 160.

While processing request 156a-i, the auxiliary file system monitor 158 will update the relevant array in the auxiliary file system structure 160 with information about block numbers. At that point, double-allocation of a particular block will be detected, because the block numbers allocated in the request 156a-i are already recorded as allocated to file F. The auxiliary file system monitor 158 may then utilise the checker structure 160 to correct the file system persistent structure 124.

In one variation, this process may occur substantially simultaneously with the updating of the file system persistent structure 124 itself. In this embodiment, the server 104 will not consider a request operation to be fully completed until the auxiliary file system monitor 158 confirms that the operation is successful and error-free. If the auxiliary file system monitor 158 does not confirm the operation, for example when a corruption has been detected, the repair process is initiated. In the repair process, the server 104 rebuilds the free space table (forming part of the file system persistent structure 124) from the arrays in the auxiliary file system structure 160. The server 104 then re-executes the request operation and allocates new blocks to the request operation.

The on-demand file system recovery component 164 is invoked in an event of a catastrophic file system failure. This may be detected as an irrecoverable inconsistency in the file system data or metadata, or may be initiated manually or automatically by a system administrator. The on-demand file system recovery component 114 uses the auxiliary file system structure 160 built by the pre-emptive recovery component 108 to restore a part or whole of the file system 120 which has failed. This is possible by means of a continuous maintenance of the FOL 156 as the file system 120 is accessed in use, and the timely, but asynchronous, updating of the checker file system image 110 by the auxiliary file system monitor 158 during operation of the file system 120.

The recovery components 162, 164 may comprise part of the auxiliary file system monitor 158 or alternatively may comprise separate software or hardware entities on the auxiliary server 152 (which may take the form of a file checker server).

A method of operation of the present invention will now be described with reference to FIG. 4.

Step 200: Storage Request Received

At step 200, a storage request (e.g. an I/O request) which will modify the file system state (e.g. a write, directory creation or other modification to the file system state) is received.

The method then proceeds to step 202.

Step 202: Modify File System Structure

At step 202, the file system 120 is modified by the storage request R received in step 200. At this point, the file system persistent structure 124 is also updated to reflect the modified blocks and/or directories.

Step 204: Generate New Data Record

At step 204, a new data record is generated based on the storage request received in step 200. The data record comprises metadata relating to the modification made to the file system state and may comprise the location of blocks modified by the storage request or other data relating to the change which has occurred. This step occurs substantially simultaneously with the previous step.

Step 206: Update FOL With New Data Record

At step 206, the FOL 156 is updated to include the new data record. This is done at substantially the same time as the modification to the file system state, so that the FOL 156 comprises an accurate record of the modifications to the file system state. Since the updating of the FOL 156 by adding a new data record is not resource-intensive, this can be done without impacting on the client side system latency.

The method then proceeds to step 208.

Step 208: Delay

At step 208, a delay period is specified. The delay period is prior to the execution of step 210 in which the file system image is updated. This is so that the updating of the file system image is not cotemporaneous with the file system access by the client or client to ensure that the system latency visible to the client is reduced.

The delay period may be any suitable time to ensure that the file system latency is not increased inadvertently. In other words, the delay is in order to reduce the system overheads associated with the building of the updated auxiliary file system structure 160 whilst a client is accessing the file system 120. If the server 104 is lightly loaded, the delay period may essentially be negligible. However, if the server 104 is under heavy use, a typical period of delay may be of the order of 3 ms.

Step 210: Update Auxiliary File System Structure

At step 210, the auxiliary file system structure 160 is updated. The FOL records 156a-i updated in step 206 are processed by the auxiliary file system monitor 158 to build additional data-structures (the auxiliary file system structure 160) that are not necessary for a normal operation of a file system, but useful for its recovery.

Whilst the FOL 156 is continuously updated every time a relevant change or update is made to the file system 120 in step 206, the auxiliary file system structure 160 is updated asynchronously with the FOL 156 and step 210 is carried out after the delay at step 208.

Once the file system image 110 has been updated, the method then continues to monitor for storage requests which modify the system file state, in which case steps 200-210 are repeated for each storage request.

The above method step enable an up-to-date and accurate auxiliary file system structure 160 to be created which can then be used in a recovery process. The present invention is operable to utilise this auxiliary file system structure 160 in two different recovery processes.

FIGS. 5 to 7 illustrate alternative recovery options for the present invention. FIGS. 5 and 6 illustrate a flow chart of methods of pre-emptive file system recovery whilst the file system is operating and has not yet failed, but when an inconsistency or error is detected which has not been identified by the file system 120 itself FIG. 5 relates to an asynchronous mode whereby the recovery process can be invoked at any time to check and/or repair the file system structure. FIG. 6 relates to a synchronous mode whereby the checking forms part of an approval process of a request modifying the file system structure.

With reference to FIG. 6, a first embodiment of the recovery process will be described.

Step 300: Storage Request Received

At step 300, a storage request (e.g. an I/O request) which will modify the file system state (e.g. a write, directory creation or other modification the file system state) is received.

The method then proceeds to step 302.

Step 302: Modify File System Structure

At step 302, the file system 120 is modified by the storage request R received in step 300. At this point, the file system persistent structure 124 is also updated to reflect the modified blocks and/or directories.

Step 304: Generate New Data Record

At step 304, a new data record is generated based on the storage request received in step 300. The data record comprises metadata relating to the modification made to the file system state and may comprise the location of blocks modified by the storage request or other data relating to the change which has occurred. This step occurs substantially simultaneously with the previous step.

Step 306: Update FOL With New Data Record

At step 306, the FOL 156 is updated to include the new data record. This is done at substantially the same time as the modification to the file system state, so that the FOL 156 comprises an accurate record of the modifications to the file system state. Since the updating of the FOL 156 by adding a new data record is not resource-intensive, this can be done without impacting on the client side system latency.

The method then proceeds to step 308.

Step 308: Delay

At step 308, a delay period is specified. The delay period is prior to the execution of step 310 in which the file system image 160 is updated. This is so that the updating of the file system image is not cotemporaneous with the file system access by the client or client to ensure that the system latency visible to the client is reduced.

The delay period may be any suitable time to ensure that the file system latency is not increased inadvertently. In other words, the delay is in order to reduce the system overheads associated with the building of the updated auxiliary file system structure 160 whilst a client is accessing the file system 120. If the server 104 is lightly loaded, the delay period may essentially be negligible. However, if the server 104 is under heavy use, a typical period of delay may be of the order of 3 ms.

Step 310: Update Auxiliary File System Structure

At step 310, the auxiliary file system structure 160 is updated. The FOL 156 records updated in step 306 are processed by the auxiliary file system monitor 158 to build additional data-structures (the auxiliary file system structure 160) that are not necessary for a normal operation of a file system, but useful for its recovery.

Whilst the FOL 156 is continuously updated every time a relevant change or update is made to the file system 120 in step 306, the auxiliary file system structure 160 is updated asynchronously with the FOL 156 and step 310 is carried out after the delay at step 308.

In other words, when a request 156a-i is processed, the auxiliary file system monitor 158 will update the relevant array in the auxiliary file system structure 160 with information about block numbers.

Step 312: Scan File System Data and Metadata

At step 312, the auxiliary file system structure 160 is scanned. The auxiliary file system monitor 158 is operable to scan the auxiliary file system structure 160 and identify errors and inconsistencies which my not be identified by the file system 120 itself. Such an inconsistency may be due to a software bug in the server code or a media failure and results in a table storing the set of free blocks becoming corrupted. This error will not be detected by the file system 120 itself.

The method then proceeds to step 314.

Step 314: Inconsistency Detected?

At step 312, the auxiliary file system structure 160 data is scanned. It is then determined whether an inconsistency has been detected in the auxiliary file system structure 160 (and, therefore, in the structure of the file system 120 itself).

One such inconsistency may be double-allocation of a particular block. For example, if a particular block is already allocated to a particular file, then a write to the same block for a different file will be detected in the scan in step 312 because the block numbers allocated in the request 156-i are already recorded as allocated to another file.

If an inconsistency is detected, the method proceeds to step 316. Otherwise, if no errors or inconsistencies are detected, the method proceeds to step 318.

Step 316: Correct Inconsistency

At step 316, an inconsistency detected in the file system 120 detected using the file system image 160 is corrected using the FOL 156 and stored record of indices in the file system image 160. In other words, the auxiliary file system monitor 158 may then utilise the auxiliary file system structure 160 to correct the file system persistent structure 124.

This is done by the server 104 rebuilding the free space table (forming part of the file system persistent structure 124) from the arrays in the auxiliary file system structure 160. The server 104 then re-executes the request operation and allocates new blocks to the request operation.

The method then proceeds to step 318.

Step 318: End

At step 318, the process is terminated. If a further storage request is received, the method starts again at step 300.

The above method may, as described, be invoked automatically or manually at any time when the file system 120 is operational in order to correct incidental errors or inconsistencies which have yet to lead to (but, if unchecked, may cause) file system failures or crashes. The above method can check and, if necessary, repair elements of the file system structure which have been modified irrespective of when they have been modified (provided they have a record in the FOL 156).

However, in a further embodiment, the above checking process may form part of an integral process whereby a write or modification to the file system 120 will only be accepted once the monitor has approved the change. This is illustrated in FIG. 6.

Step 400: Storage Request Received

At step 400, a storage request (e.g. an I/O request) which will modify the file system state (e.g. a write, directory creation or other modification the file system state) is received.

The method then proceeds to step 402.

Step 402: Generate New Data Record

At step 402, a new data record is generated based on the storage request received in step 300. The data record comprises metadata relating to the modification made to the file system state and may comprise the location of blocks modified by the storage request or other data relating to the change which has occurred. This step occurs substantially simultaneously with the previous step.

Step 404: Update FOL With New Data Record

At step 404, the FOL 156 is updated to include the new data record. This is done at substantially the same time as the modification to the file system state, so that the FOL 156 comprises an accurate record of the modifications to the file system state. Since the updating of the FOL 156 by adding a new data record is not resource-intensive, this can be done substantially simultaneously with the previous step without impacting on the client side system latency.

The method then proceeds to step 406.

Step 406: Update Auxiliary File System Structure

At step 406, the auxiliary file system structure 160 is updated. The FOL 156 records updated in step 304 are processed by the auxiliary file system monitor 158 to build additional data-structures (the auxiliary file system structure 160) that are not necessary for a normal operation of a file system, but useful for its recovery.

In this embodiment, the auxiliary file system structure 160 is continuously updated at substantially the same time as the FOL 156 is being continuously updated, i.e. every time a relevant change or update is made to the file system 120 in step 406. In other words, when a request 156a-i is processed, the auxiliary file system monitor 158 will update the relevant array in the auxiliary file system structure 160 with information about block numbers.

However, a delay step may be introduced if desired as set out in the previous embodiments.

Step 408: Scan File System Image Update

At step 408, the auxiliary file system structure 160 data is scanned to review the update received in step 406. The auxiliary file system monitor 158 is operable to scan the auxiliary file system structure 160 and identify changes due to the updated record 156a-i. At this point, any errors and inconsistencies will be identified which may not be identified by, or even be visible to, the file system 120 itself.

The method then proceeds to step 410.

Step 410: Inconsistency Detected?

At step 410, the file system image data is scanned. It is then determined whether an inconsistency has been detected in the auxiliary file system structure 160 (and, therefore, in the structure of the file system 120 itself).

If an inconsistency is detected, the method proceeds to step 412. Otherwise, if no errors or inconsistencies are detected, the method proceeds to step 414.

Step 412: Correct Inconsistency

At step 412, an inconsistency detected in the file system 120 detected using the auxiliary file system structure 160 is corrected using the FOL 156 and stored record of indices in the auxiliary file system structure 160. In other words, the auxiliary file system monitor 158 utilises the checker file structure image 160 to correct the file system persistent structure 124.

This is done by the server 104 rebuilding the file system persistent structure 124 from the arrays in the auxiliary file system structure 160. The server 104 then re-executes the request operation and allocates new blocks to the request operation for processing in step 418.

The method then proceeds to step 414.

Step 414: Modify, File System Structure

At step 414, the file system 120 is modified by the storage request R received in step 400 and approved by the previous method steps. At this point, the file system persistent structure 124 is also updated to reflect the modified blocks and/or directories.

If an error was detected in step 410 and corrected in step 412, then prior to modification of the file system structure, the server 104 re-executes the storage request operation and allocates new blocks to the request operation.

The method then proceeds to step 416.

Step 416: End

At step 416, the process is terminated. If a further storage request is received, the method starts again at step 400.

The above method operates as a failsafe checking process when the file system 120 is operational in order to correct incidental errors or inconsistencies which, if unchecked or corrected, may lead to file system failures or crashes. Whilst this method may introduce client-side latency, the failsafe process of checking and approving new modifications to the file system 120 maintains a file system persistent structure 124 which is substantially error-free and significantly reduces the likelihood of a catastrophic error occurring.

Should a catastrophic file system crash occur, a complete disaster recovery process will be required to be initiated. The present invention can assist in this, particularly if the auxiliary file system 152 is located on a server separate from that of the file system 120. In this regard, if the FOL records 156 on the auxiliary file system 152 are preserved, then the file system 120 can be repaired. FIG. 7 illustrates a flow chart of a method of file system recovery following a catastrophic system failure or crash.

Step 500: Initialise

At step 500, the process is initialised. The system recovery component may be enabled either automatically or manually, for example by a system administrator, in the event of an unrecoverable file system failure which will require a rebuild of the file system structure.

Step 502: Access Auxiliary File System Structure

At step 502, the auxiliary file system structure 160 (or file system image) data is accessed by the on-demand recovery component 164. The on-demand recovery component 164 is operable to utilise the indices stored in the auxiliary file system structure 160 to rebuild and/or repair the file system 120. The method then proceeds to step 504.

Step 504: Rebuild File System

At step 504, the on-demand recovery component 164 is operable to rebuild the file system 120 using the indices of the auxiliary file system structure 160. The on-demand recovery component 164 can then correct fatal errors with regard to file locations, file associations, block allocations and file directories.

Step 506: End

At step 506, the file system 120 has been corrected and the procedure is terminated.

Variations of the above embodiments will be apparent to the skilled person. The precise configuration of hardware and software components may differ and still fall within the scope of the present invention.

For example, the present invention has been described with reference to controllers in hardware. However, the controllers and/or the invention may be implemented in software.

Additionally, whilst the present embodiment relates to arrangements operating predominantly in off-host firmware or software, an on-host arrangement could be used.

The controller or method of the present embodiments may be used to manage a plurality of separate file systems (potentially located on different servers) if required. Indeed, the use of a dedicated auxiliary server 152 facilitates this approach.

Any combination of the above examples, methods and arrangements may be used. For example, an auxiliary checker server may be operable to execute one or more of the described examples and alternatives.

Embodiments of the present invention have been described with particular reference to the examples illustrated. While specific examples are shown in the drawings and are herein described in detail, it should be understood, however, that the drawings and detailed description are not intended to limit the invention to the particular form disclosed. It will be appreciated that variations and modifications may be made to the examples described within the scope of the present invention.

1. A method of enabling data recovery on a storage system comprising at least one data storage resource, the or each data storage resource comprising a file system operable to process storage requests to said data storage resource from one or more client computers, the file system including a file system structure component for data storage management on said data storage resource, the method comprising:
a) receiving, on a computer system, a storage request operable to modify the file system;
b) processing, on a computer system, the storage request and updating the file system structure component based on said storage request;
c) generating, on a computer system, a data record for said modification by said storage request;
d) updating, on a computer system, an auxiliary file system structure component utilising said data record, the auxiliary file system structure component being separate from said file system structure component and being operable to enable recovery of said file system in the event of an error or failure occurring.

2. A method according to claim 1, wherein steps b) and c) are performed synchronously.

3. A method according to claim 1, wherein step d) is carried out asynchronously from steps b) and c).

4. A method according to claim 3, wherein step d) further comprises waiting for a predetermined time period prior to updating said auxiliary file system structure component.

5. A method according to claim 4, wherein said pre-determined time period is dependent upon the load on the data storage resource.

6. A method according to claim 1, wherein the or each data record is stored in a file operations log comprising a plurality of data records recording storage requests modifying the file system structure component.

7. A method according to claim 6, wherein said file operations log is immutable.

8. A method according to claim 1, wherein said file system structure component and/or said auxiliary file system structure component comprise one or more tables relating to data storage allocation on said data storage resource.

9. A method according to claim 8, wherein said tables comprise one or more arrays relating one or more files to a specific data storage allocation area on said storage resource.

10. A method according to claim 9, wherein said data storage allocation area comprises one or more data blocks.

11. A method according to claim 1, further comprising the step of:
f) determining, from said updating in step d), whether errors are present in said file system structure component and, if an error is detected, correcting said error in the file system structure component.

12. A method according to claim 11, wherein said correcting comprises rebuilding the file system structure component from the auxiliary file system structure component.

13. A method according to claim 1, further comprising the step of:
g) rebuilding the file system structure component from the auxiliary file system structure component.

14. A method of enabling data recovery on a storage system comprising at least one data storage resource, the or each data storage resource comprising a file system operable to process storage requests to said data storage resource from one or more client computers, the file system including a file system structure component for data storage management on said data storage resource, the method comprising:
a) receiving, on a computer system, a storage request requesting a modification to the file system;
b) generating, on a computer system, a data record for said modification by said storage request;
c) updating, on a computer system, an auxiliary file system structure component utilising said data record, said auxiliary file system structure component being separate from said file system structure component;
d) determining, from said updating in step c), whether errors are present in said file system structure component and, if an error is detected, correcting said error in the file system structure component; and
f) processing, on a computer system, the storage request and updating the file system structure component based on said storage request.

15. A method according to claim 14, wherein said correcting in step d) comprises rebuilding the file system structure component from the auxiliary file system structure component.

16. A method according to claim 14, wherein if an error is detected such that the storage request received in step a) is allocated to an incorrect data storage allocation area, the processing in step f) comprises allocating the storage request to the correct data storage allocation area.

17. A method according to claim 14, wherein if no error is detected, the processing in step f) comprises executing the request as received by the data storage resource.

18. A controller operable to enable data recovery on a storage system comprising at least one data storage resource, the or each data storage resource comprising a file system operable to process storage requests to said data storage resource from one or more client computers, the file system including a file system structure component for data storage management on said data storage resource, the controller being operable to; receive a storage request operable to modify the file system; process the storage request and update the file system structure component based on said storage request; generate a data record for said modification by said storage request; and update an auxiliary file system structure component utilising said data record, the auxiliary file system structure component being separate from said file system structure component and being operable to enable recovery of said file system in the event of an error or failure occurring.

19. A controller according to claim 18, further operable to determine, from the operation of updating the auxiliary file system structure component, whether errors are present in said file system structure component and, if an error is detected, correct said error in the file system structure component.

20. A controller according to claim 19, wherein said operation of correcting comprises rebuilding the file system structure component from the auxiliary file system structure component.

21. A controller according to claim 18, further operable to rebuild the file system structure component from the auxiliary file system structure component.

22. A controller according to claim 18, operable to enable data recovery on a storage system comprising a plurality of data storage resources each comprising a file system.

23. A controller according to claim 18, wherein the controller is implemented in either hardware or software.

24. A controller operable to enable data recovery on a storage system comprising at least one data storage resource, the or each data storage resource comprising a file system operable to process storage requests to said data storage resource from one or more clients, the file system including a file system structure component for data storage management on said data storage resource, the controller being operable to: receive a storage request requesting a modification to the file system; generate a data record for said modification by said storage request; update an auxiliary file system structure component utilising said data record, said auxiliary file system structure component being separate from said file system structure component; determine, from said operation of updating, whether errors are present in said file system structure component and, if an error is detected, correct said error in the file system structure component; and process the storage request and update the file system structure component based on said storage request.

25. A storage system comprising at least one data storage resource and the controller of claim 18.

26. A storage system comprising at least one data storage resource and the controller of claim 24.

27. A computer program product executable by a programmable processing apparatus, comprising one or more software portions for performing the steps of claim 1.

28. A computer program product executable by a programmable processing apparatus, comprising one or more software portions for performing the steps of claim 14.

29. A computer usable storage medium having a computer program product according to claim 27 stored thereon.

30. A computer usable storage medium having a computer program product according to claim 28 stored thereon.
